(19) United States
(12) Patent Application Publication
(10) Pub. No.: US 2010/0265258 A1
(43) Pub. Date: Oct. 21, 2010

(54) Flame Image Sequencing Apparatus and Method

(75) Inventor: Christopher Simon Stonier, Shropshire (GB)

Correspondence Address: KRIEG DEVAULT LLP, ONE INDIANA SQUARE, SUITE 2800, INDIANAPOLIS, IN, 46204-2079, US

(73) Assignee: DOMESTIC FIRE APPLIANCES LIMITED, Market Drayton, Shropshire (GB)

(21) Appl. No.: 12/601,976

(22) PCT Filed: May 23, 2008
(86) PCT No.: PCT/GB2008/001750

§ 371 Date: May 17, 2010

(30) Foreign Application Priority Data
May 26, 2007 (GB) 0710174.4

(51) Int. Cl. G06T 13/00

(52) U.S. Cl. 345/473

(57) ABSTRACT

An imaging apparatus is disclosed that is designed to display a set of images on a screen for a fire. The apparatus includes a display screen, a controller capable of displaying a set of images to the display screen, and a masking member to prevent a viewer from viewing a part of the display screen.

### CROSS REFERENCE TO RELATED APPLICATIONS

The present application is related and claims priority to International Application No. PCT/GB2008/001750 filed May 23, 2008 entitled Imaging Apparatus that published as WO 2008/145966 A2 on Dec. 4, 2008, which is related and claims priority to Great Britain application Serial Number 0710174.4 filed on May 26, 2007, both of which are hereby incorporated by reference in their entirety.

### BACKGROUND

The present invention relates to an imaging apparatus, and more particularly but not exclusively relates to an imaging apparatus for a fire.

Following the introduction of relatively small DVD players with liquid crystal display screens, attempts have been made to incorporate such players into fires. However, the image definition of such players is relatively poor. The screen size is relatively small, so that the image requires magnification, for example, by lenses. The player itself is relatively large in comparison with the space available in the fire. The screen is generally recognizable by the viewer as an LCD screen so that the viewer is aware that the image is a flame effect rather than a real flame. The image or image sequence is often “jumpy”, betraying the fact that the image sequence is on a continuous repeating loop.

In other conventional arrangements larger LCD screens are used; however, larger screens typically require PC based hardware and software which is relatively expensive and bulky. Therefore, developments in the technology are desirable.

### SUMMARY

According to a first aspect of the present invention, there is provided an imaging apparatus for a fire, the apparatus including a display screen on which an image is displayable in use and a controller which is arranged to provide a set of images to the display screen for display.

In one form, the apparatus includes masking means, which may be arranged to substantially prevent a viewer viewing part of the display screen. The masking means is arranged to substantially prevent the viewer from viewing a top part and opposed side parts of the display screen.

The masking means can include a masking member. In one form, the masking member includes a first region and a second region. The first region permits the transmission of more light than the second region. The second region substantially prevents the transmission of light. The first region substantially permits the transmission of light, and may be transparent. In yet another form, the masking member includes a transition region between the first region and the second region.

The second region in use can extend around three sides of the first region, and may extend around two opposed vertical sides and a top side of the first region in use.

The masking member can be substantially planar, and may be rectangular. The second region can extend from a lower part of each of the vertical sides of the rectangular masking member. The second region can further extend upwardly inwardly in use from the lower part of each of the vertical sides, and may extend at an angle of between 75° and 85° to the horizontal, and may optimally extend at an angle of 80° to the horizontal.

The masking member can include a layer, which may extend over the second region. In one form, the layer includes a material which restricts the transmission of light therethrough.

In another form, the controller is arranged to repeatedly provide the set of images to the display screen for display. Each image shows a subject, and when displayed in sequence in use the set shows the subject in motion.

The set of images can further include at least one transition image, which may be positioned at the start or end of the set. In one aspect, the transition image includes two images of the subject which are combined. Each of the combined images can show the subject in a different condition. Each of the combined images can have an intensity. The intensity of each of the combined images can be less than the intensity of the other images of the set.

In one form, one of the combined images is in sequence with the end of the sequence of images of the set. One of the combined images can be in sequence with the start of the sequence of images of the set.

The set can include a plurality of transition images. Each of the combined images relating to the end of the sequence can be sequentially less intense than the respective previous end of sequence combined image. Each of the start of sequence combined images can be more intense than the respective previous start of sequence combined image.

In one representative form, the controller is a microcontroller, which is in the form of a circuit board including a processor, serial ports, inputs, outputs, a clock and a graphic accelerator.

The apparatus can also include a scaling device. The controller can be configured and arranged to provide an output signal to the scaling device, which may be in the form of a transistor-transistor-logic signal. Possibly the scaling device is arranged to provide a low voltage differential signaling signal to the display screen.

The scaling device can also be arranged to increase the number of pixels displaying the image. In one representative form, the controller is arranged to provide a 640×480 pixel image to the scaling device, and the scaling device is arranged to provide at least a 1280×720 pixel image to the screen.

In one form, the imaging apparatus is configured and operable to provide a flame effect for a fire. In this form, the image is an image of a flame, and the set of images provides the effect of a moving flame thereby creating a simulated fire.

According to another aspect of the present invention, there is provided a fire, the fire including imaging apparatus as described above in the preceding statements.

According to a another aspect of the present invention, there is provided a method of displaying an image within a fire, the method including the steps of providing imaging apparatus, the imaging apparatus including a display screen on which an image is displayable in use and a controller which is arranged to provide a set of images to the display screen for display.

### BRIEF DESCRIPTION OF THE DRAWINGS

FIG. 1 is a side sectional schematic view of one embodiment of the imaging apparatus.

FIG. 2 is a front view of part of one embodiment of the imaging apparatus.

FIG. 3 is a view of part of one embodiment of a masking member.

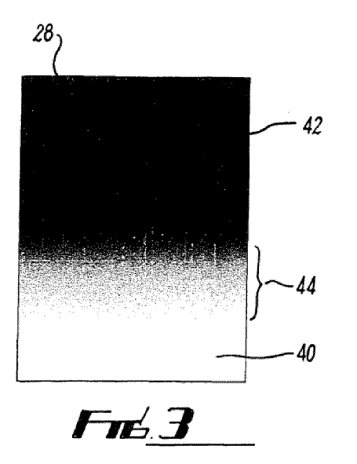

FIG. 4 is a schematic view of a conventional set of images.

FIG. 5 is a schematic view of another set of images.

### DESCRIPTION OF ILLUSTRATIVE EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated device, and such further applications of the principles of the invention as illustrated therein being contemplated as would normally occur to one skilled in the art to which the invention relates.

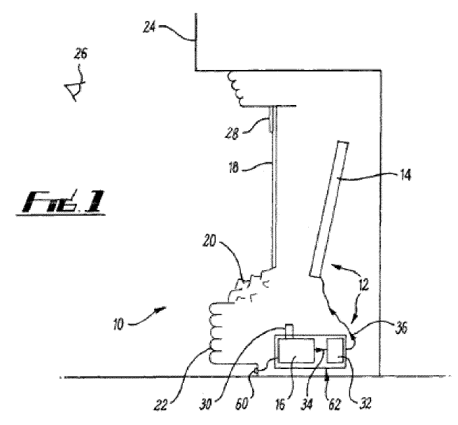

FIG. 1 shows a fire 10, the fire 10 including imaging apparatus 12, the imaging apparatus 12 including a display screen 14 and a controller 16 which is arranged to provide an image or images to the display screen 14 for display.

As shown in FIG. 1, the fire 10 could include a grate 22 and fuel effect members 20, and the fire 10 could be mounted in a fire surround 24.

The display screen 14 is in the form of a liquid crystal display (LCD) screen, and could be mounted in any suitable orientation.

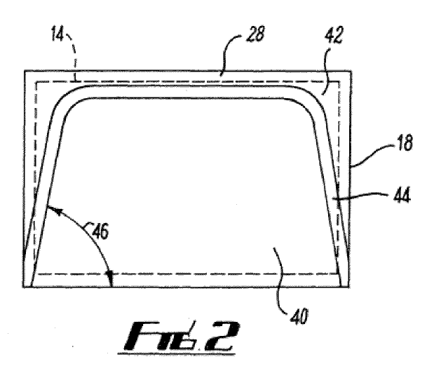

The imaging apparatus 12 includes masking means including a masking member 18 which is positioned in front of the display screen 14 so that a viewer 26 views the display screen 14 through the masking member 18. Referring to FIG. 2, which shows the masking member 18 from the front, with the outline in dotted lines of the display screen 14 behind, the masking member 18 includes a first transparent or clear region 40 and a second substantially opaque region 42, the first region 40 permitting the transmission of more light than the second region 42, the first region 40 substantially permitting the transmission of light and the second region 42 substantially preventing the transmission of light. The masking member 18 includes a transition region 44 between the first and second regions 40, 42.

The masking member 18 could include a layer 28 which extends over the second region 42, the layer 28 being formed of a material which restricts the transmission of light. The layer 28 could be formed of, for example, paint, a dye, smoke, or any other suitable material.

The second region 42 extends around three sides of the first region 40, extending from a lower part of each of the opposed vertical sides of the masking member upwardly and inwardly. In one example, the second region 42 extends upwardly and inwardly from each corner of the masking member 18 at an angle 46 of between 75° and 85° to the horizontal and optimally at an angle 46 of 80° to the horizontal.

As shown in FIG. 2, the second region 42 will in use substantially prevent a viewer 26 from being able to see the side and top edges of the display screen 14. Additionally, the transition region 44 provides a transition from light to dark, so that the viewer 26 will not see any sharp edges. Thus the viewer 26 will see flame effect images displayed by the screen 14 through the first transparent region 40, and these images will appear more realistic since the viewer 26 cannot see the edges of the screen 14.

Various modifications could be made to the masking member 18. The masking member 18 could be of any suitable size and shape, and could be formed of any suitable material. The opacity of the second region 42 could be varied. For example, the second region 42 might not necessarily be completely opaque. The second region 42 could be any suitable color. The opacity could be provided by any suitable means. The degree of opacity in the second region 42 could vary. For example in one example the opacity of the second region 42 could be provided by smoking glass, and the opacity of the second region 42 could vary across the second region 42. The transition region 44 could be of any suitable size and shape. The first, transparent region 40 could be of any suitable size and shape.

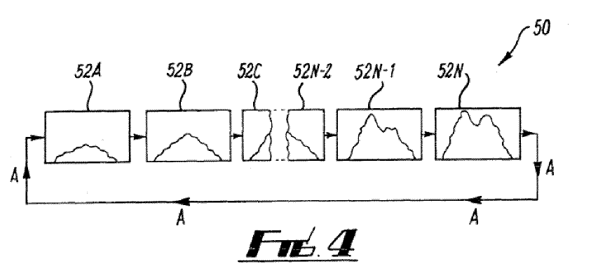

FIG. 4 shows a conventional arrangement in which the controller 16 is arranged to repeatedly provide a set 50 of images 52A, 52B, . . . , 52N to the display screen 14 for display. The set 50 of images could include a sequence of images showing a subject which in the case of FIG. 4 is a flame, which when displayed shows the subject in motion.

In the example shown in FIG. 4, the image of the flame in each sequential image 52A, 52B, . . . , 52N increases in size. After the last image 52N is displayed, the set of images 50 is displayed sequentially again as indicated by arrows A, so that following image 52N, image 52A is displayed. The viewer 26 will therefore notice a jump in flame size between the relatively large flame shown in image 52N and the relatively small flame shown in image 52A.

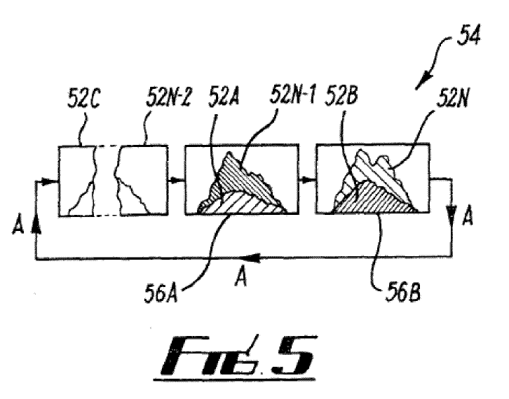

FIG. 5 shows another set of images 54 including two transition images 56A, 56B, each of which include two images of the subject which are combined, each of the combined images showing the subject in a different condition.

In the first transition image 56A, one of the combined images is the first image of the set 52A and the other of the combined images is the second to last image of the set 52N-1. Each of the combined images within the transition images 56A, 56B is less intense than the other images of the set. The second transition image 56B includes the second image of the sequence 52B as one of the combined images and the last image of the set 52N as the other of the combined images, and again the combined images are less intense than the other images of the set.

In the first transition image 56A, the combined second to last image of the set 52N-1 is more intense than the first image of the set 52A. In the second transition image 56B, the last image of the set 52N is less intense than the second image of the set 52B. Thus, the end of set combined images become less intense with each successive transition image, and the start of set combined images become more intense with each successive transition image.

In this specification the term “intensity” is used in a relative sense to signify the degree of visibility of an image relative to the other images of the set which do not include combined images. Thus, for example the third image 52C and the third to last image 52N-2 (which are not transition images) would have an intensity of 100%. In the first transition image 56A, the first image 52A could have an intensity of 33%, and the second to last image 52N-1 could have an intensity of 67%. In the second transition image 56B, the second image 52B could have an intensity of 67%, and the last image 52N could have an intensity of 33%. Thus the transition images 56A, 56B provide a transition fade out of the end of the set and a transition fade in of the beginning of the set, so that there is no jump in images between the end and the start of the set.

The set of images 54 could include any suitable number of images N. In one example, the set of images 54 includes 40 images. The images are normally displayed at approximately 25 images per second, and thus the set of images 54 displays in a loop approximately 1.6 seconds long. In one example, the set of 40 images includes six transition images which include combined images, the intensities of which are shown in Table 1.

TABLE 1

| Image Number of | | Image Number of | |
|---|---|---|---|
| set | Intensity | set | Intensity |
| 33 | 100% | | |
| 34 | 100% | | |
| 35 | 85% | 1 | 15% |
| 36 | 70% | 2 | 30% |
| 37 | 55% | 3 | 45% |
| 38 | 40% | 4 | 60% |
| 39 | 35% | 5 | 75% |
| 40 | 10% | 6 | 90% |
| 7 | 100% | | |

In the example shown in table 1, the images 7 to 34 are single images of intensity 100%. Images 35 to 40 are combined with images 1 to 6 to form transition images. The intensity of the end of set images 35 to 40 reduces successively, and the intensity of the start of set images 1 to 6 increases successively, thus providing a transition from the flame of image 34 to the flame of image 7.

The use of six transition images in a 40 image set has been found satisfactory for the display of flame images in a fire.

Various other modifications could be made without departing from the scope of the invention. The image sets could include any suitable number of images. The image sets could include any suitable number of transition images. The transition images could include any suitable number of combined images. The combined images could be of any suitable opacity. The image sets could be run at any suitable speed.

There is thus provided a means by which a relatively short set of images can provide a more realistic moving flame effect image for the viewer 26.

Typically, liquid crystal display (LCD) screens are available in two formats. Smaller, lower resolution screens use a TTL (transistor-transistor-logic) interface which is a relatively slow interface, and subsequently screen resolutions are restricted to the order of 640×480 pixels. Higher screen resolutions and larger screen sizes use an LVDS (low voltage differential signaling) interface, which is a faster interface, capable of addressing a higher number of pixels. Typically, a display system using a TTL interface will have lower memory and processor requirements since the image sizes are smaller, but the display output will be relatively small and of low definition. In contrast, a display system using LVDS will have relatively higher memory and processor requirements, but will produce a higher resolution image capable of display on a larger screen.

Referring to FIG. 1, the controller 16 is in the form of a microcontroller, which includes a processor, serial ports, inputs, outputs, an internal clock and a graphic accelerator. The microcontroller could be in signal communication with an infrared sensor 60, which could sense control signals provided by a remote control device (not shown) operated by the viewer 26. The apparatus could include a memory medium 30, which could be in the form of flash memory, and could store the set of images 54. Alternatively, the microcontroller could include permanently installed flash memory into which the set of images 54 is loaded.

The controller 16 is in signal communication with a scaling device 32, which in turn provides a signal to the display screen 14. The output signal 34 provided by the controller 16 to the scaling device 32 is in the form of a TTL signal, and could enable an image of 640×480 pixels. The scaling device 32 is arranged to convert the TTL signal to an LVDS signal, and is arranged to increase the number of pixels displaying the image. For example, the image of pixel size 640×480 pixels from the controller 16 could be increased by the scaling device 32 so that the scaling device 32 enables an image of 1280×720 pixels to the display screen 14.

The scaling device 32, which could be in the form of an upscaling device, thus permits the use of a relatively simple microcontroller which could be arranged to store a relatively short set of images 54. For example as described previously the set of images could include 40 images requiring relatively low memory storage, and a relatively small processor. The scaling device 32 converts the output of the microcontroller 16 to an output suitable for a relatively large screen size. Thus the displayed image size is increased, and the necessity for providing enlargement or magnification means of the screen 14 is eliminated.

In one example, the scaling device 32 could be provided on the same circuit board 62 as the controller 16. The circuit board 62 can be of relatively small dimensions, with a relatively low power requirement.

Various other modifications can be made without departing from the scope of the invention. The controller could be of any suitable form, and could include any suitable components. The scaling device could be of any suitable form.

There is thus provided a fire which has a number of advantages over conventional arrangements. The fire includes a masking screen, which improves the visual appearance of the flame image by masking the sharp edges of the LCD screen. The image sets displayed include transition images which smoothly transition between the start and end of image sets, further improving the realism of the flame images. The use of a scaling device enables a relatively simple and economic microcontroller to be used to store the images and provide the images to a relatively large display screen 14.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. In reading the claims it is intended that when words such as “a,” “an,” and “at least one” are used, there is no intention to limit the claim to only one item unless specifically stated to the contrary in the claim.

1-44. (canceled)

45. An apparatus comprising:
a display screen;
a controller operable to provide a set of images to the display screen, wherein the set of images comprises a plurality of images of a flame and said controller is configured and operable to display the set of images on the display screen as a moving flame thereby creating a simulated fire; and
a masking member configured and arranged to at least partially prevent a viewer from viewing at least a part of the display screen.

46. The apparatus of claim 45, wherein the masking member is configured and arranged to substantially prevent viewing a top part and opposed side parts of the display screen.

47. The apparatus of claim 45, wherein the masking member includes a first region and a second region.

48. The apparatus of claim 47, wherein the first region permits the transmission of more light than the second region.

49. The apparatus of claim 47, wherein the second region substantially prevents the transmission of light.

50. The apparatus of claim 47, wherein the first region substantially permits the transmission of light.

51. The apparatus of claim 47, wherein the masking member includes a transition region between the first region and the second region.

52. The apparatus of claim 47, wherein the second region extends around three sides of the first region.

53. The apparatus of claim 47, wherein the second region extends around two opposed vertical sides and a top side of the first region.

54. The apparatus of claim 45, wherein the masking member is substantially planar.

55. The apparatus of claim 45, wherein the masking member is substantially rectangular.

56. The apparatus of claim 47, wherein the second region extends at an angle of between 75° and 85° to the horizontal.

57. The apparatus of claim 47, wherein the second region extends from a lower part of each of the vertical sides of the rectangular masking member.

58. The apparatus of claim 47, wherein the second region extends upwardly inwardly in use from the lower part of each of the vertical sides.

59. The apparatus of claim 47, where the second region extends at an angle of 80° to the horizontal.

60. The apparatus of claim 47, wherein the masking member includes a layer that extends over the second region.

61. The apparatus of claim 60, wherein the layer includes a material which restricts the transmission of light therethrough.

62. The apparatus of claim 45, wherein the controller is operable to repeatedly provide the set of images to the display screen for display.

63. The apparatus of claim 45, wherein the set of images includes at least one transition image.

64. The apparatus of claim 63, wherein the transition image is positioned at a start or an end of the set of images.

65. The apparatus of claim 64, wherein the transition image includes at least two images of flames in the set of images which are combined to create the transition image.

66. The apparatus of claim 65, wherein each of the combined images shows the flame in a different condition.

67. The apparatus of claim 66, wherein one of the combined images is in sequence with an end of a sequence of images of the set of images.

68. The apparatus of claim 66, wherein one of the combined images is in sequence with a start of a sequence of images of the set of images.

69. The apparatus of claim 65, wherein each of the combined images has an intensity, and the intensity of each of the combined images is less than the intensity of the other images of the set of images.

70. The apparatus of claim 64, wherein each of the combined images relating to the end of the sequence is sequentially less intense than a respective previous end of sequence combined images.

71. The apparatus of claim 68, wherein each of the start of sequence combined images is more intense than a respective previous start of sequence combined images.

72. The apparatus of claim 45, in which the controller is a microcontroller, which is in the form of a circuit board including a processor, serial ports, inputs, outputs, a clock and a graphic accelerator.

73. The apparatus of claim 45, further comprising a scaling device connected with the controller.

74. The apparatus of claim 73, wherein the controller is operable to provide an output signal to the scaling device that is in the form of a transistor-transistor-logic signal.

75. The apparatus of claim 73, wherein the scaling device is operable to provide a low voltage differential signaling signal to the display screen.

76. The apparatus of claim 73, wherein the scaling device is operable to increase a number of pixels displaying the image.

77. The apparatus of claim 76, wherein the controller is operable to provide a 640×480 pixel image to the scaling device, and the scaling device is operable to provide at least a 1280×720 pixel image to the display screen.

78. A method comprising:
providing an imaging apparatus including a display screen and a controller;
providing a masking member to at least partially prevent a viewer from viewing at least a part of the display screen;
determining a set of images comprising a plurality of flame images to display on the display screen; and
displaying the set of images on the display screen to create a simulated fire on said display screen; and
providing at least one transition image between an end of the set of images and a beginning of the set of images.

79. The method of claim 78, wherein the transition image comprises a combination of two or more respective flame images in the set of images.

80. The method of claim 78, wherein the combination generates a respective combined flame image in a different condition.

81. The method of claim 36, wherein the different condition comprises at least a portion of the respective combined flame image having a lower intensity level than flame images contained in the set of images.

82. An apparatus comprising:
a display screen;
a controller connected with the display screen operable to generate images on the display screen; and
a storage medium containing a plurality of images in the form of a fire, wherein the controller is operable to display the plurality of images on the display screen to create a simulated fire, wherein at least one of the plurality of images comprises a transition image generated as a function of a combination of two or more images contained in the plurality of images that has an intensity level less than that of any single image contained in the plurality of images.

83. The apparatus of claim 82, further comprising a masking member structured to prevent viewing a part of the display screen.

84. The apparatus of claim 82, the masking member further comprising:
a first region substantially permitting the transmission of light;
a second region, extending around three sides of the first region, substantially preventing the transmission of light; and
a transition region located between the first region and the second region.

85. The apparatus of claim 84, the second region extending at an angle of between 75° and 85° to the horizontal.
